(19) United States
(12) Patent Application Publication
(10) Pub. No.: US 2016/0167410 A1
(43) Pub. Date: Jun. 16, 2016

(54) INKJET RECORDING APPARATUS

(71) Applicant: FUJIFILM Corporation, Tokyo (JP)

(72) Inventor: Kensuke TAKADA, Kanagawa (JP)

(73) Assignee: FUJIFILM Corporation, Tokyo (JP)

(21) Appl. No.: 14/974,621

(22) Filed: Dec. 18, 2015

Related U.S. Application Data
(63) Continuation of application No. PCT/JP2014/066667, filed on Jun. 24, 2014.

(30) Foreign Application Priority Data
Jul. 2, 2013 (JP) 2013-138806

(51) Int. Cl. B41J 13/00

(52) U.S. Cl. CPC B41J 13/0009

(57) ABSTRACT

An inkjet recording apparatus that can detect the floating of a recording medium and foreign matter with high precision. The inkjet recording apparatus includes a conveyor for conveying a recording medium along a conveying path, an inkjet head that draws an image by dropping ink on a recording surface of the recording medium conveyed by the conveyor, a detector that includes a light projecting section for emitting a detection beam parallel to a conveying surface and a light receiving section on which the detection beam is incident, and variable detection height mechanisms that change a height of the detection beam from the conveying surface in a first state in which the conveyor is driven and does not convey the recording medium and a second state in which the conveyor is driven and conveys the recording medium.

### CROSS-REFERENCE TO RELATED APPLICATIONS

The present application is a Continuation of PCT International Application No. PCT/JP2014/066667 filed on Jun. 24, 2014 claiming priority under 35 U.S.C §119(a) to Japanese Patent Application No. 2013-138806 filed on Jul. 2, 2013. Each of the above applications is hereby expressly incorporated by reference, in their entirety, into the present application.

### BACKGROUND OF THE INVENTION

1. Field of the Invention

The present invention relates to an inkjet recording apparatus, and more particularly, to an inkjet recording apparatus that includes a variable detection height mechanism for changing a detection height.

2. Description of the Related Art

An inkjet recording apparatus records a predetermined image on a recording surface of a sheet by discharging droplets of ink to the sheet (recording medium), which is conveyed along a predetermined conveying path, from inkjet heads. When the sheet to be conveyed floats above a conveying surface in the inkjet recording apparatus, there is a problem in that recording quality deteriorates due to the change of a distance (throw distance: TD) between the nozzle face of the head and the recording surface of the sheet or the nozzle face becomes damaged due to rubbing between the sheet and the nozzle face of the head. For this reason, a sheet floating detection device is installed on the conveying path of the sheet in the inkjet recording apparatus and performs processing for stopping the conveyance of the sheet when floating of a prescribed value or more is detected.

A light projecting section and a light receiving section are installed so as to face each other with the conveying path of the sheet interposed therebetween, a detection beam is emitted toward the light receiving section from the light projecting section at a position having a predetermined height from the conveying surface, and whether or not the detection beam is received is detected, so that the detection of the floating of a sheet is performed. That is, when the floating of the sheet occurs, the sheet blocks the detection beam. Accordingly, whether or not the floating of the sheet occurs is determined on the basis of whether or not the sheet blocks the detection beam (for example, JP2007-76109A).

### SUMMARY OF THE INVENTION

Incidentally, even when foreign matter of a recording medium or the like remaining on the conveying path remains at a printing position of the inkjet head other than when an image is to be recorded on a recording medium, the nozzle face becomes damaged due to contact between the inkjet head and the foreign matter or nozzles become clogged if the foreign matter is fine dust (fabric chips or the like).

Further, when detection is performed over the entire conveying path in a conveyance method that does not have a conveying path having a constant height as in a conveyance method using an impression cylinder, the amount of detection light is significantly changed in recesses of claw portions (grippers) or the like for holding the recording medium. For this reason, false detection is likely to occur.

The invention has been made in consideration of the above-mentioned circumstances, and an object of the invention is to provide an inkjet recording apparatus that can detect the floating of a recording medium and foreign matter with high precision.

In order to achieve the object, the invention provides an inkjet recording apparatus including: conveying means for conveying a recording medium along a conveying path; an inkjet head that draws an image by dropping ink on a recording surface of the recording medium conveyed by the conveying means; detection means that includes a light projecting section for emitting a detection beam parallel to a conveying surface and a light receiving section on which the detection beam is incident; and a variable detection height mechanism that changes a height of the detection beam from the conveying surface in a first state in which the conveying means is driven and does not convey the recording medium and a second state in which the conveying means is driven and conveys the recording medium.

According to this aspect, it is possible to provide an inkjet recording apparatus that can detect the floating of a recording medium and foreign matter with high precision.

In this aspect, it is preferable that the inkjet recording apparatus further includes a control mechanism that detects whether or not the detection beam is received by the light receiving section and stops the conveying means when the detection beam is not received.

According to this aspect, since the inkjet recording apparatus includes the control mechanism that stops the conveying means when the detection beam is not received, the inkjet head can be protected.

In this aspect, it is preferable that a control, which maintains a first detection height from the conveying surface and makes the control mechanism effective over the entire conveying path, is performed in the first state, and it is preferable that a control, which maintains a second detection height from the conveying surface and makes the control mechanism effective only in an area in which the recording medium is present in the conveying path, is performed in the second state.

In this aspect, it is preferable that the detection height of the first state is 1.0 mm or more from the conveying surface.

In this aspect, it is preferable that the detection height of the second state is adjusted according to the thickness of the recording medium by the variable detection height mechanism.

In this aspect, it is preferable that the inkjet head is movable between a drawing position where the inkjet head draws an image by dropping ink on a recording surface of the recording medium conveyed by the conveying means and a retreat position where the inkjet head is retreated from the conveying means and is moved to the retreat position in the first state and moved to the drawing position in the second state.

In this aspect, it is preferable that the detection means detects foreign matter in the first state and detects the floating of the recording medium in the second state.

In this aspect, it is preferable that a speed of the conveying means in the first state is lower than that in the second state.

According to this aspect, it is possible to detect foreign matter with higher precision by reducing the speed of the conveying means in the first state.

In this aspect, it is preferable that the conveying means is a conveying drum for holding the recording medium on an outer peripheral surface thereof by suction and conveying the recording medium by being rotated.

This aspect is particularly effective in a conveyance method that does not have a conveying path having a constant height as in a conveyance method using an impression cylinder like the conveying drum for holding the recording medium on an outer peripheral surface thereof by suction and conveying the recording medium by being rotated.

In this aspect, it is preferable that the variable detection height mechanism includes a light-projecting parallel flat plate and light-projecting parallel flat plate rotation-driving means. The light-projecting parallel flat plate is disposed in front of the light projecting section so as to allow the detection beam emitted from the light projecting section to pass through the light-projecting parallel flat plate, is provided so as to be rotatable about an axis parallel to the conveying surface and orthogonal to the detection beam, and changes a height of the detection beam, which passes through the light-projecting parallel flat plate and is emitted from the light-projecting parallel flat plate, by being rotated; and the light-projecting parallel flat plate rotation-driving means rotationally drives the light-projecting parallel flat plate.

According to this aspect, it is possible to change a detection height by rotating the light-projecting parallel flat plate that is disposed in front of the light projecting section. When the light-projecting parallel flat plate is inclined with respect to an optical axis of the detection beam, the emission position of the detection beam emitted from the light-projecting parallel flat plate is shifted upward or downward due to the action of refraction. The emission position of the detection beam is changed according to an incident angle of the detection beam that is incident on the light-projecting parallel flat plate, and the incident angle is changed according to the rotation angle of the light-projecting parallel flat plate. Accordingly, since it is possible to change the emission position of the detection beam by rotating the light-projecting parallel flat plate, it is possible to change the height of the detection beam (detection height). Since the optical axis of the detection beam is shifted by using the action of the refraction of the light-projecting parallel flat plate as described above, it is possible to easily adjust a detection height with high precision. Further, since detection does not depend on other structures, stable detection can be performed for a long time.

In this aspect, it is preferable that the variable detection height mechanism includes a light-receiving parallel flat plate and light-receiving parallel flat plate rotation-driving means. The light-receiving parallel flat plate is disposed in front of the light receiving section so as to allow the detection beam having passed through the light-projecting parallel flat plate to pass through the light-receiving parallel flat plate, is provided so as to be rotatable about an axis parallel to the conveying surface and orthogonal to the detection beam, and changes a height of the detection beam, which passes through the light-receiving parallel flat plate and is emitted from the light-receiving parallel flat plate, by being rotated; and the light-receiving parallel flat plate rotation-driving means rotationally drives the light-receiving parallel flat plate.

According to this aspect, since the light-receiving parallel flat plate is also provided on the light-receiving side, it is possible to adjust the height of the detection beam. Accordingly, detection can be performed with higher precision.

According to the invention, it is possible to detect the floating of a recording medium and foreign matter with high precision.

### BRIEF DESCRIPTION OF THE DRAWINGS

FIG. 1 is a schematic view showing the entire configuration of an inkjet recording apparatus to which the invention is applied.

FIG. 2 is a block diagram showing the schematic configuration of a control system of the inkjet recording apparatus.

FIG. 3 is a front view of a first embodiment of a detection device.

FIG. 4 is a plan view of the first embodiment of the detection device.

FIG. 5 is a graph showing a relationship between the rotation angle (inclination angle) of a light-projecting glass parallel flat plate and the displacement X of a detection beam in a height direction.

FIG. 6A illustrates the light-projecting glass parallel flat plate rotated in a counterclockwise direction corresponding to plus.

FIG. 6B illustrates the light-projecting glass parallel flat plate which corresponds to 0 degree.

FIG. 6C illustrates the light-projecting glass parallel flat plate rotated in a clockwise direction corresponding to minus.

FIG. 7 is a flowchart illustrating steps of detecting foreign matter.

FIG. 8 is a flowchart illustrating steps of detecting the floating of a sheet.

FIG. 9 is a front view of a second embodiment of the detection device.

FIG. 10 is a plan view of the second embodiment of the detection device.

### DESCRIPTION OF THE PREFERRED EMBODIMENTS

Preferred embodiments of an inkjet recording apparatus according to the invention will be described in detail below with reference to the accompanying drawings.

<<Entire Configuration>>

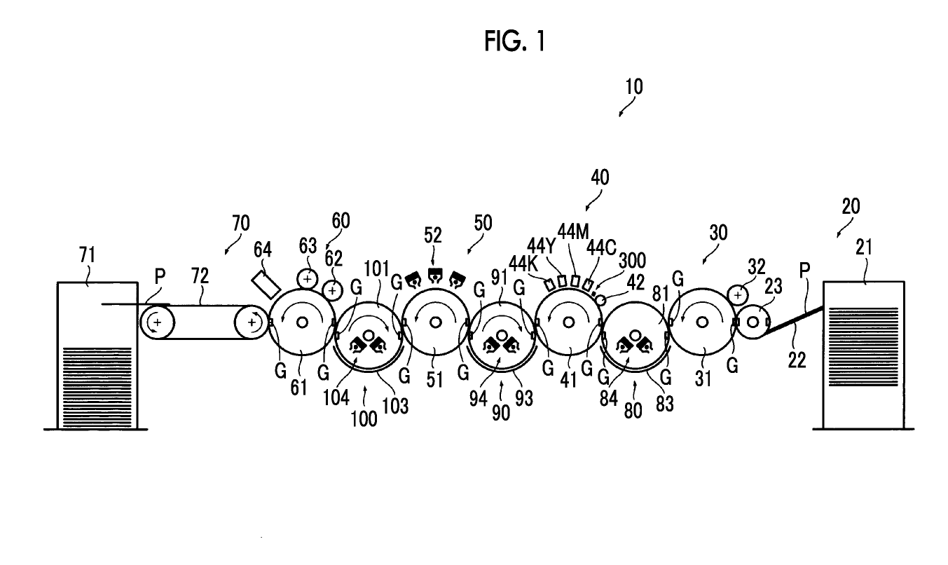

FIG. 1 is a schematic view showing the entire configuration of an inkjet recording apparatus in which detection means and a variable detection height mechanism according to the invention are assembled.

An inkjet recording apparatus 10 shown in FIG. 1 is a recording apparatus that records an image and the like on a sheet P with water-based ink (ink containing water in a solvent) by an inkjet method. The inkjet recording apparatus 10 includes: a sheet feed section 20 that feeds the sheet P; a treatment liquid applying section 30 that applies predetermined treatment liquid to the recording surface of the sheet P; an image recording section 40 that draws a color image by dropping ink droplets, which have colors of cyan (C), magenta (M), yellow (Y), and black (K), on the recording surface of the sheet P by inkjet heads; an ink drying section 50 that dries the ink droplets dropped on the sheet P; a fixing section 60 that fixes the image recorded on the sheet P; and a recovery section 70 that recovers the sheet P.

The treatment liquid applying section 30, the image recording section 40, the ink drying section 50, and the fixing section 60 are provided with conveying drums 31, 41, 51, and 61 as conveying means for the sheet P, respectively. The sheet P is conveyed through the treatment liquid applying section 30, the image recording section 40, the ink drying section 50, and the fixing section 60 by the conveying drums 31, 41, 51, and 61.

Each of the conveying drums 31, 41, 51, and 61 is formed so as to correspond to the width of the sheet, and is driven by a motor (not shown) so as to be rotated (rotated counterclockwise in FIG. 1). Grippers G are provided on the peripheral surface of each of the conveying drums 31, 41, 51, and 61, and the sheet P is conveyed while an end portion of the sheet P is gripped by the gripper G. Since the grippers G are provided at two points (at an interval of 180°) on the peripheral surface of each of the conveying drums 31, 41, 51, and 61 in this embodiment, two sheets can be conveyed during one rotation.

Further, since a plurality of suction holes are formed on the peripheral surfaces of each of the conveying drums 31, 41, 51, and 61, the sheet P is held on the outer peripheral surface of each of the conveying drums 31, 41, 51, and 61 while the back of the sheet P is sucked by a vacuum from the suction holes. Meanwhile, in this embodiment, the sheet P is sucked by a vacuum and held on the outer peripheral surface of each of the conveying drums 31, 41, 51, and 61 by suction. However, the sheet P may be electrostatically attracted and held on the outer peripheral surface of each of the conveying drums 31, 41, 51, and 61.

A transfer cylinder 80 is disposed between the treatment liquid applying section 30 and the image recording section 40, a transfer cylinder 90 is disposed between the image recording section 40 and the ink drying section 50, and a transfer cylinder 100 is disposed between the ink drying section 50 and the fixing section 60. The sheet P is conveyed between the respective units by the transfer cylinders 80, 90, and 100.

The transfer cylinders 80, 90, and 100 include transfer cylinder bodies 81, 91, and 101 that are formed of frame bodies and grippers G that are provided on the transfer cylinder bodies 81, 91, and 101. The transfer cylinder bodies 81, 91, and 101 are formed so as to correspond to the width of the sheet, and are driven by motors (not shown) so as to be rotated (rotated clockwise in FIG. 1). Accordingly, the grippers G are rotated on the same circumference. The sheet P is conveyed while an end portion of the sheet P is gripped by the grippers G. Meanwhile, since a pair of grippers G are disposed at positions that are symmetric with each other with a rotation axis interposed therebetween in this embodiment, two sheets can be conveyed during one rotation.

Arc-shaped guide plates 83, 93, and 103 are provided along a conveying path of the sheet P below the transfer cylinders 80, 90, and 100, respectively. The sheet P, which is conveyed by the transfer cylinders 80, 90, and 100, is conveyed while the back (the surface opposite to the recording surface) of the sheet P is guided by the guide plates 83, 93, and 103.

Further, dryers 84, 94, and 104, which blow hot air to the sheet P conveyed by the transfer cylinder 80, 90, and 100 are disposed in the transfer cylinders 80, 90, and 100, respectively. While the sheet P is conveyed, hot air blown from the dryers 84, 94, and 104 is applied to the recording surfaces of the sheets P that are conveyed by the respective transfer cylinders 80, 90, and 100.

The sheep P, which is fed from the sheet feed section 20, is delivered to the conveying drum 31 of the treatment liquid applying section 30, and is delivered to the conveying drum 41 of the image recording section 40 from the conveying drum 31 of the treatment liquid applying section 30 via the transfer cylinder 80. Then, the sheet P is delivered to the conveying drum 51 of the ink drying section 50 from the conveying drum 41 of the image recording section 40 via the transfer cylinder 90, and is delivered to the conveying drum 61 of the fixing section 60 from the conveying drum 51 of the ink drying section 50 via the transfer cylinder 100. After that, the sheet P is delivered to the recovery section 70 from the conveying drum 61 of the fixing section 60. The sheet P is subjected to necessary processing during this series of conveying steps, so that an image is formed on the recording surface.

Meanwhile, the sheet P is conveyed on the conveying drums 31, 41, 51, and 61 so that the recording surface of the sheet P faces the outside, and is conveyed on the transfer cylinders 80, 90, and 100 so that the recording surface of the sheet P faces the inside.

The configuration of each unit of the inkjet recording apparatus 10 of this embodiment will be described in detail below.

<Sheet Feed Section>

The sheet feed section 20 includes a sheet feed device 21, a sheet feed tray 22, and a transfer cylinder 23, and continuously feeds sheets P to the treatment liquid applying section 30 one by one.

The sheet feed device 21 sequentially feeds sheets P, which are stacked in a magazine (not shown), to the sheet feed tray 22 one by one from above.

The sheet feed tray 22 sends the sheet P, which is fed from the sheet feed device 21, to the transfer cylinder 23.

The transfer cylinder 23 receives the sheet P that is sent from the sheet feed tray 22, conveys the sheet P along a predetermined conveying path, and delivers the sheet P to the conveying drum 31 of the treatment liquid applying section 30.

A general-purpose recording sheet is used as the sheet P, not a dedicated inkjet sheet.

<Treatment Liquid Applying Section>

The treatment liquid applying section 30 applies predetermined treatment liquid to the recording surface of the sheet P. The treatment liquid applying section 30 includes the conveying drum (hereinafter, referred to as a “treatment liquid applying drum”) 31 that conveys the sheet P, and a treatment liquid applying device 32 that applies predetermined treatment liquid to the recording surface of the sheet P conveyed by the treatment liquid applying drum 31.

The treatment liquid applying drum 31 receives the sheet P from the transfer cylinder 23 of the sheet feed section 20 (receives the sheet P while an end portion of the sheet P is gripped by the gripper G), and conveys the sheet P by being rotated.

The treatment liquid applying device 32 applies treatment liquid, which functions to agglomerate coloring materials of ink, to the recording surface of the sheet P that is conveyed by the treatment liquid applying drum 31. The treatment liquid applying device 32 is formed of, for example, a coater that coats an object with treatment liquid by a roller. The treatment liquid applying device 32 applies treatment liquid to the recording surface of the sheet P by making a coating roller, of which the peripheral surface has been subjected to the application of the treatment liquid, come into pressure contact with the surface of the sheet P. Since ink is dropped after the treatment liquid is applied in advance, it is possible to suppress feathering, bleeding, and the like even though a general-purpose recording sheet is used. Accordingly, it is possible to perform high-quality recording. Meanwhile, the treatment liquid applying device 32 may be adapted to apply treatment liquid by the same droplet discharge head as an inkjet head to be described below, or may be adapted to apply treatment liquid by a spray.

According to the treatment liquid applying section 30 having the above-mentioned configuration, the sheet P is conveyed along a predetermined conveying path by the treatment liquid applying drum 31, and treatment liquid is applied to the recording surface from the treatment liquid applying device 32 while the sheet P is conveyed. Then, the sheet P of which the recording surface has been subjected to the application of treatment liquid is delivered to the transfer cylinder 80 from the treatment liquid applying drum 31 at a predetermined position.

Here, the dryer 84 is installed in the transfer cylinder 80 as described above and hot air is blown to the guide plate 83. While the sheet P is conveyed to the image recording section 40 from the treatment liquid applying section 30 by the transfer cylinder 80, hot air is applied to the recording surface and the treatment liquid applied to the recording surface is dried (a solvent component contained in the treatment liquid is evaporated and removed).

<Image Recording Section>

The image recording section 40 draws a color image on the recording surface of the sheet P by dropping ink droplets, which have colors of C, M, Y, and K, on the recording surface of the sheet P. The image recording section 40 includes: a conveying drum (hereinafter, referred to as an “image recording drum”) 41 that conveys the sheet P; a sheet pressing roller 42 that presses the recording surface of the sheet P conveyed by the image recording drum 41 to make the back of the sheet P come into close contact with the peripheral surface of the image recording drum 41; a detection device 300 that detects the floating of the sheet P having passed through the sheet pressing roller 42 and foreign matter; and inkjet heads 44C, 44M, 44Y, and 44K that discharge ink droplets having colors of C, M, Y, and K to the sheet P.

The image recording drum 41 receives the sheet P from the transfer cylinder 80, and conveys the sheet P by being rotated. In this case, as described above, the sheet P is conveyed while being held on the outer peripheral surface of the image recording drum 41 by suction. Accordingly, the sheet P is conveyed along a conveying path that is set on a conveying surface serving as an arc-shaped surface (an area in which the sheet P is received from the transfer cylinder 80 and is delivered to the transfer cylinder 90) defined by the outer peripheral surface of the image recording drum 41. Meanwhile, the conveying path passes through the middle of the image recording drum 41 and is set so as to correspond to the width of the sheet P.

The sheet pressing roller 42 is installed near a sheet receiving position (a position where the sheet P is received from the transfer cylinder 80) of the image recording drum 41 and a pressing force is applied to the sheet pressing roller 42 by a pressing mechanism (not shown) so that the sheet pressing roller 42 comes into pressure contact with the peripheral surface of the image recording drum 41. Since the sheet P, which is delivered to the image recording drum 41 from the transfer cylinder 80, is nipped by passing through the sheet pressing roller 42, the back of the sheet P comes into close contact with the outer peripheral surface of the image recording drum 41.

The detection device 300 detects the floating of the sheet P that has passed through the sheet pressing roller 42 (the floating, which corresponds to a predetermined height or more, of the sheet from the outer peripheral surface of the image recording drum 41). The detection device 300 applies a laser beam (detection beam) to a position that corresponds to a predetermined height from the outer peripheral surface of the image recording drum 41 (conveying surface) over the image recording drum 41, and detects the floating of the sheet P by detecting whether or not the laser beam has been blocked. That is, since the laser beam is blocked by the sheet P when the sheet P floats, the detection device 300 detects the floating of the sheet P by detecting whether or not the laser beam has been blocked.

Meanwhile, when the image recording drum 41 is rotated and the sheet P is not conveyed in the inkjet recording apparatus, the detection device 300 detects the foreign matter present on the image recording drum 41. The configuration of the detection device 300 will be described in detail below.

The four inkjet heads 44C, 44M, 44Y, and 44K are disposed in the rear of the detection device 300, and are disposed at regular intervals along the conveying path of the sheet P. Each of the inkjet heads 44C, 44M, 44Y, and 44K is formed of a line head corresponding to the width of the sheet, and discharges ink droplets, which have a corresponding color, to the image recording drum 41 from a nozzle array formed on a nozzle face of each inkjet head.

According to the image recording section 40 having the above-mentioned configuration, the sheet P is conveyed along a predetermined conveying path by the image recording drum 41. First, the sheet P, which is delivered to the image recording drum 41 from the transfer cylinder 80, is nipped by the sheet pressing roller 42 and comes into close contact with the outer peripheral surface of the image recording drum 41. Next, whether or not floating is present is detected by the detection device 300. Then, ink droplets having colors of C, M, Y, and K are dropped on the recording surface from the respective inkjet heads 44C, 44M, 44Y, and 44K, so that a color image is drawn on the recording surface.

Here, water-based ink in which each color and a thermoplastic resin are dispersed in ink is used in the inkjet recording apparatus 10 of this embodiment. Even though this water-based ink is used, it is possible to perform high-quality recording without causing feathering, bleeding, and the like since predetermined treatment liquid is applied to the sheet P as described above.

Further, when the floating of the sheet P is detected by the detection device 300, the conveyance of the sheet is stopped and a warning is issued.

The sheet P on which an image has been drawn is delivered to the transfer cylinder 90, is conveyed along a predetermined conveying path by the transfer cylinder 90, and is delivered to the conveying drum 51 of the ink drying section 50. Meanwhile, since the dryer 94 is installed in the transfer cylinder 90 as described above, hot air is blown to the guide plate 93. Processing for drying ink is performed by the ink drying section 50 provided in the rear, but is also performed while the sheet P is conveyed by the transfer cylinder 90.

Meanwhile, although not shown, the image recording section 40 is provided with a maintenance unit that performs the maintenance of the inkjet heads 44C, 44M, 44Y, and 44K. Accordingly, the inkjet heads 44C, 44M, 44Y, and 44K are adapted to be moved to the maintenance unit and subjected to necessary maintenance as necessary.

<Ink Drying Section>

The ink drying section 50 dries a liquid component remaining on the sheet P after the image is recorded. The ink drying section 50 includes the conveying drum (hereinafter, referred to as an “ink drying drum”) 51 that conveys the sheet P, and an ink drying device 52 that performs drying processing on the sheet P conveyed by the ink drying drum 51.

The ink drying drum 51 receives the sheet P from the transfer cylinder 90, and conveys the sheet P by being rotated.

The ink drying device 52 includes, for example, dryers (in this embodiment, three dryers disposed along the conveying path of the sheet P), and dries ink (evaporates a liquid component remaining on the sheet) by blowing hot air to the sheet P conveyed by the ink drying drum 51.

According to the ink drying section 50 having the above-mentioned configuration, the sheet P is conveyed by the ink drying drum 51. Further, since hot air is blown to the recording surface from the ink drying device 52 while the sheet P is conveyed, ink applied to the recording surface is dried.

After that, the sheet P having passed through the ink drying device 52 is delivered to the transfer cylinder 100 from the ink drying drum 51 at a predetermined position. Then, the sheet P is conveyed along a predetermined conveying path by the transfer cylinder 100, and is delivered to the conveying drum 61 of the fixing section 60.

Meanwhile, since the dryer 104 is installed in the transfer cylinder 100 as described above, hot air is blown to the guide plate 103. Accordingly, the sheet P is also subjected to drying processing while being conveyed by the transfer cylinder 100.

<Fixing Section>

The fixing section 60 fixes the image, which is recorded on the recording surface, by heating and pressurizing the sheet P. The fixing section 60 includes the conveying drum (hereinafter, referred to as a “fixing drum”) 61 that conveys the sheet P, heating rollers 62 and 63 that perform heating/pressurizing processing on the sheet P conveyed by the fixing drum 61, and an in-line sensor 64 that detects the temperature, humidity, and the like of the sheet P on which an image has been recorded and picks up the recorded image.

The fixing drum 61 receives the sheet P from the transfer cylinder 100, and conveys the sheet P by being rotated.

The heating rollers 62 and 63 melt the thermoplastic resin, which is dispersed in the ink, by heating and pressurizing the ink, which is applied to the recording surface of the sheet P, and form the ink into the shape of a film. At the same time, the heating rollers 62 and 63 correct deformation, such as cockling and curling, occurring in the sheet P. Each of the heating rollers 62 and 63 is formed so as to have substantially the same width as the fixing drum 61, and is heated up to a predetermined temperature by a heater that is built thereinto. Further, each of the heating rollers 62 and 63 is made to come into pressure contact with the peripheral surface of the fixing drum 61 with a predetermined pressing force by pressurizing means (not shown). Since the sheet P passes through the heating rollers 62 and 63, the sheet P is heated and pressurized by the heating rollers 62 and 63.

The in-line sensor 64 includes a thermometer, a hygrometer, a CCD line sensor, and the like. The in-line sensor 64 detects the temperature, humidity, and the like of the sheet P, which is conveyed by the fixing drum 61, and picks up the image recorded on the sheet P. Abnormalities of the apparatus, discharge defects of the head, and the like are checked on the basis of the detection results of the in-line sensor 64.

According to the fixing section 60 having the above-mentioned configuration, the sheet P is conveyed by the fixing drum 61 and the heating rollers 62 and 63 come into pressure contact with the recording surface during the conveyance of the sheet P and are heated and pressurized. Accordingly, the thermoplastic resin, which is dispersed in the ink, is melted and the ink is formed into the shape of a film. At the same time, deformation occurring on the sheet P is corrected.

Then, the sheet P, which has been subjected to fixing processing, is delivered to the recovery section 70 from the fixing drum 61 at a predetermined position.

<Recovery Section>

The recovery section 70 recovers the sheets P, which have been subjected to a series of recording processing, while stacking the sheets P in a stacker 71. The recovery section 70 includes: the stacker 71 that recovers the sheets P; and a sheet discharge conveyor 72 that receives the sheet P, which has been subjected to fixing processing in the fixing section 60, from the fixing drum 61, conveys the sheet P along a predetermined conveying path, and discharges the sheet P to the stacker 71.

The sheet P, which has been subjected to fixing processing in the fixing section 60, is delivered to the sheet discharge conveyor 72 from the fixing drum 61, is conveyed to the stacker 71 by the sheet discharge conveyor 72, and is recovered in the stacker 71.

<<Control System>>

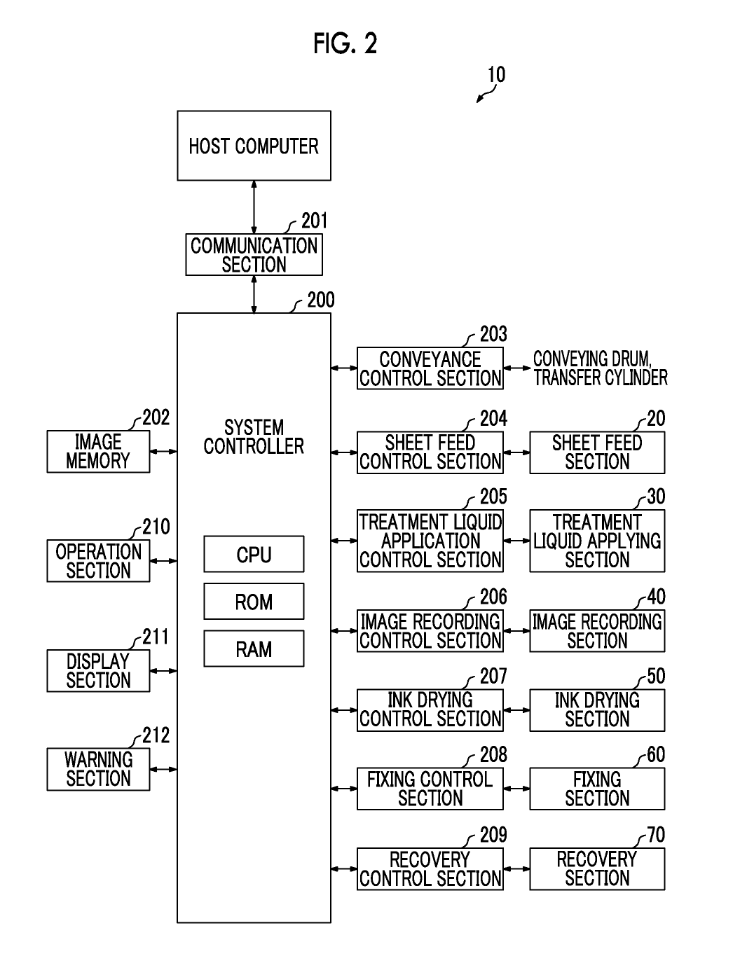

FIG. 2 is a block diagram showing the schematic configuration of a control system of the inkjet recording apparatus 10 of this embodiment.

As shown in FIG. 2, the inkjet recording apparatus 10 includes a system controller 200, a communication section 201, an image memory 202, a conveyance control section 203, a sheet feed control section 204, a treatment liquid application control section 205, an image recording control section 206, an ink drying control section 207, a fixing control section 208, a recovery control section 209, an operation section 210, a display section 211, a warning section 212, and the like.

The system controller 200 functions as control means for integrally controlling the respective sections of the inkjet recording apparatus 10 and functions as arithmetic means for performing various kinds of arithmetic processing. The system controller 200 includes a CPU, a ROM, a RAM, and the like, and is operated according to a predetermined control program. The control program executed by the system controller 200 and various kinds of data necessary for control are stored in the ROM.

The communication section 201 includes a necessary communication interface, and sends and receives data to and from a host computer connected to the communication interface.

The image memory 202 functions as means for temporarily storing various kinds of data included in image data, and reads and writes data through the system controller 200. Image data, which are input from the host computer through the communication section 201, are stored in the image memory 202.

The conveyance control section 203 controls the driving of the conveying drums 31, 41, 51, and 61, which are the conveying means for the sheet P of the treatment liquid applying section 30, the image recording section 40, the ink drying section 50, and the fixing section 60, and the transfer cylinders 80, 90, and 100.

That is, the conveyance control section 203 controls the driving of the motor that drives each of the conveying drums 31, 41, 51, and 61, and controls the opening and closing of the grippers G of each of the conveying drums 31, 41, 51, and 61.

Likewise, the conveyance control section 203 controls the driving of the motor that drives each of the transfer cylinders 80, 90, and 100, and controls the opening and closing of the grippers G of each of the transfer cylinders 80, 90, and 100.

Further, since each of the conveying drums 31, 41, 51, and 61 is provided with a suction holding mechanism that holds the sheet P on the peripheral surface of the conveying drum by suction, the conveyance control section 203 controls the driving of the suction holding mechanism (since the sheet P is sucked by a vacuum in this embodiment, the conveyance control section 203 controls the driving of a vacuum pump as negative pressure generating means).

Furthermore, since the transfer cylinders 80, 90, and 100 are provided with the dryers 84, 94, and 104, the conveyance control section 203 controls the driving (the amount of applied heat and the amount of blown air) of the dryers.

The driving of the conveying drums 31, 41, 51, and 61 and the transfer cylinders 80, 90, and 100 is controlled according to commands from the system controller 200.

The sheet feed control section 204 controls the driving of the respective parts (the sheet feed device 21, the transfer cylinder 23, and the like) of the sheet feed section 20 according to commands from the system controller 200.

The treatment liquid application control section 205 controls the driving of the respective parts (the treatment liquid applying device 32, and the like) of the treatment liquid applying section 30 according to commands from the system controller 200.

The image recording control section 206 controls the driving of the respective parts (the sheet pressing roller 42, the inkjet heads 44C, 44M, 44Y, and 44K, and the like) of the image recording section 40 according to commands from the system controller 200.

The ink drying control section 207 controls the driving of the respective parts (the ink drying device 52, and the like) of the ink drying section 50 according to commands from the system controller 200.

The fixing control section 208 controls the driving of the respective parts (the heating rollers 62 and 63, the in-line sensor 64, and the like) of the fixing section 60 according to commands from the system controller 200.

The recovery control section 209 controls the driving of the respective parts (the sheet discharge conveyor 72, and the like) of the recovery section 70 according to commands from the system controller 200.

The operation section 210 includes necessary operation means (for example, operation buttons, a keyboard, a touch panel, and the like), and outputs operation information, which is input from the operation means, to the system controller 200. The system controller 200 performs various kinds of processing according to the operation information input from the operation section 210.

The display section 211 includes a necessary display device (for example, a LCD panel, or the like), and allows the display device to display necessary information according to commands from the system controller 200.

The warning section 212 includes a rotary warning light, a speaker, and the like, and performs a necessary warning operation (the turning-on of the rotary warning light, the generation of a warning sound from the speaker, or the like) according to commands from the system controller 200.

Meanwhile, since the image recording section 40 includes the detection device 300 as described above, the floating of the sheet P and foreign matter are detected. The results of the detection of the floating of the sheet P and foreign matter, which is performed by the detection device 300, are output to the system controller 200. When the floating of the sheet P or foreign matter are detected, the system controller 200 determines that an abnormality has occurred and instructs the conveyance control section 203 to stop the conveyance of the sheet P and instructs the warning section 212 to perform necessary warning operations (that is, the system controller 200 and the detection device 300 also operate as a control mechanism for stopping the conveying means).

Further, the image data, which are to be recorded on the sheet P, are input to the inkjet recording apparatus 10 from the host computer through the communication section 201 as described above, and are stored in the image memory 202. The system controller 200 generates dot data by performing necessary signal processing on the image data, which are stored in the image memory 202, and records an image, which is represented by the image data, on the sheet by controlling the driving of each inkjet head of the image recording section 40 according to the generated dot data.

The dot data are generally generated when color conversion processing and halftone processing are performed on the image data. The color conversion processing is processing for converting image data (for example, RGB 8-bit image data), which are represented by sRGB or the like, into data of the amounts of ink that has each color and is used in the inkjet recording apparatus 10 (in this embodiment, converting the image data into data of the amounts of ink having a color of each of C, M, Y, and K). The halftone processing is processing for converting the data of the amount of ink having each color, which are generated by the color conversion processing, into dot data, which correspond to each color, by processing such as error diffusion.

The system controller 200 generates dot data, which correspond to each color, by performing color conversion processing and halftone processing on the image data. Further, the system controller 200 records an image, which is represented by the image data, on the sheet by controlling the driving of the corresponding inkjet head according to the generated dot data that correspond to each color.

<<Recording Operation>>

Next, a recording operation, which is performed by the inkjet recording apparatus 10, will be described.

When a sheet feed command is output to the sheet feed device 21 from the system controller 200, the sheet P is fed to the sheet feed tray 22 from the sheet feed device 21. The sheet P, which is fed to the sheet feed tray 22, is delivered to the treatment liquid applying drum 31 of the treatment liquid applying section 30 via the transfer cylinder 23.

The sheet P, which is delivered to the treatment liquid applying drum 31, is conveyed along a predetermined conveying path by the treatment liquid applying drum 31. While the sheet P is conveyed, the sheet P passes through the treatment liquid applying device 32 and treatment liquid is applied to the recording surface.

The sheet P to which treatment liquid has been applied is delivered to the transfer cylinder 80 from the treatment liquid applying drum 31, is conveyed along a predetermined conveying path by the transfer cylinder 80, and is delivered to the image recording drum 41 of the image recording section 40. Further, since hot air is blown to the recording surface from the dryer 84 installed in the transfer cylinder 80 while the sheet P is conveyed by the transfer cylinder 80, the treatment liquid applied to the recording surface is dried.

Since the sheet P, which is delivered to the image recording drum 41 from the transfer cylinder 80, passes through the sheet pressing roller 42 first, the sheet P is nipped by the sheet pressing roller 42 and comes into close contact with the outer peripheral surface of the image recording drum 41. After that, whether or not the floating of the sheet P is present is detected by the detection device 300. Here, when the floating of the sheet P is detected, it is determined that an abnormal conveyance of the sheet P has occurred. Accordingly, the conveyance of the sheet is stopped and a necessary warning is issued. Meanwhile, when the floating of the sheet P is not detected, the sheet P is conveyed just as it is and ink droplets having colors of C, M, Y, and K are dropped from the respective inkjet heads 44C, 44M, 44Y, and 44K. Accordingly, a color image is drawn on the recording surface. Then, the sheet P on which the image has been drawn is delivered to the transfer cylinder 90 from the image recording drum 41.

The sheet P, which is delivered to the transfer cylinder 90, is conveyed along a predetermined conveying path by the transfer cylinder 90, and is delivered to the ink drying drum 51 of the ink drying section 50. Further, since hot air is blown to the recording surface from the dryer 94 installed in the transfer cylinder 90 while the sheet is conveyed, ink applied to the recording surface is dried.

The sheet P, which is delivered to the ink drying drum 51, is conveyed along a predetermined conveying path by the ink drying drum 51. Since hot air is blown to the recording surface from the ink drying device 52 while the sheet P is conveyed, a liquid component remaining on the recording surface is dried.

The sheet P, which has been subjected to drying processing, is delivered to the transfer cylinder 100 from the ink drying drum 51, is conveyed along a predetermined conveying path, and is delivered to the fixing drum 61 of the fixing section 60. Further, since hot air is blown to the recording surface from the dryer 104 installed in the transfer cylinder 100 while the sheet is conveyed by the transfer cylinder 100, ink applied to the recording surface is further dried.

The sheet P, which is delivered to the fixing drum 61, is conveyed along a predetermined conveying path by the fixing drum 61 and is heated and pressurized by the heating rollers 62 and 63 during the conveyance of the sheet P. Accordingly, an image, which is recorded on the recording surface, is fixed. After that, the sheet P is delivered to the sheet discharge conveyor 72 of the recovery section 70 from the fixing drum 61, is conveyed to the stacker 71 by the sheet discharge conveyor 72, and is discharged into the stacker 71.

As described above, in the inkjet recording apparatus 10 of this embodiment, the sheet P is conveyed by the drums and processing, such as the application of the treatment liquid, the drying of the treatment liquid, and the dropping, drying, and fixing of ink droplets, is performed on the sheet P while the sheet is conveyed. As a result, a predetermined image is recorded on the sheet P.

<<Detection Device (Detection Means and Variable Detection Height Mechanism)>>

### First Embodiment

### Configuration

Since the detection device 300 is assembled to the image recording section 40 in the inkjet recording apparatus 10 of this embodiment as described above, the floating of the sheet P is detected before the dropping of ink. Further, except when an image is recorded, foreign matter is detected through the detection device 300 during the driving of the conveying means.

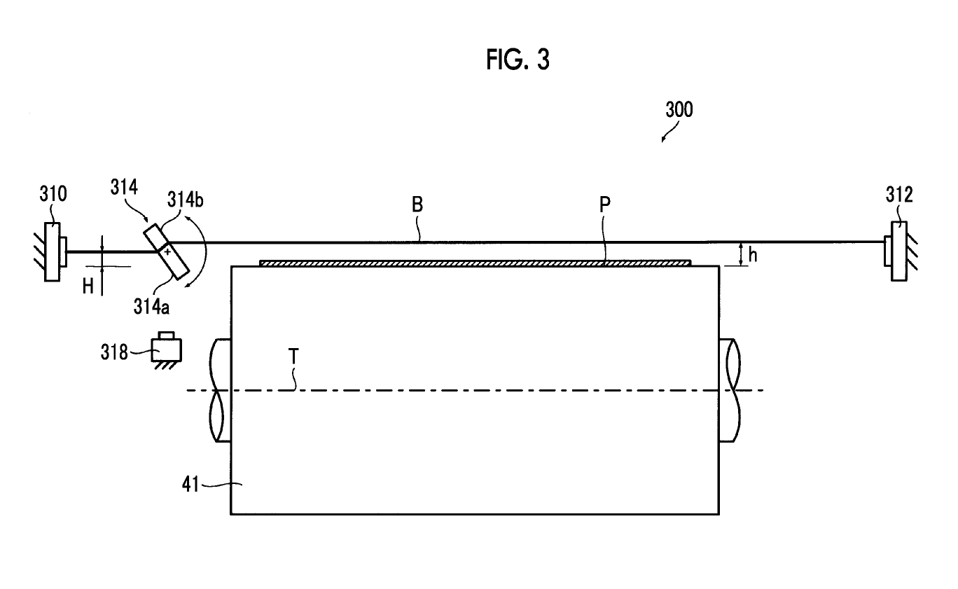

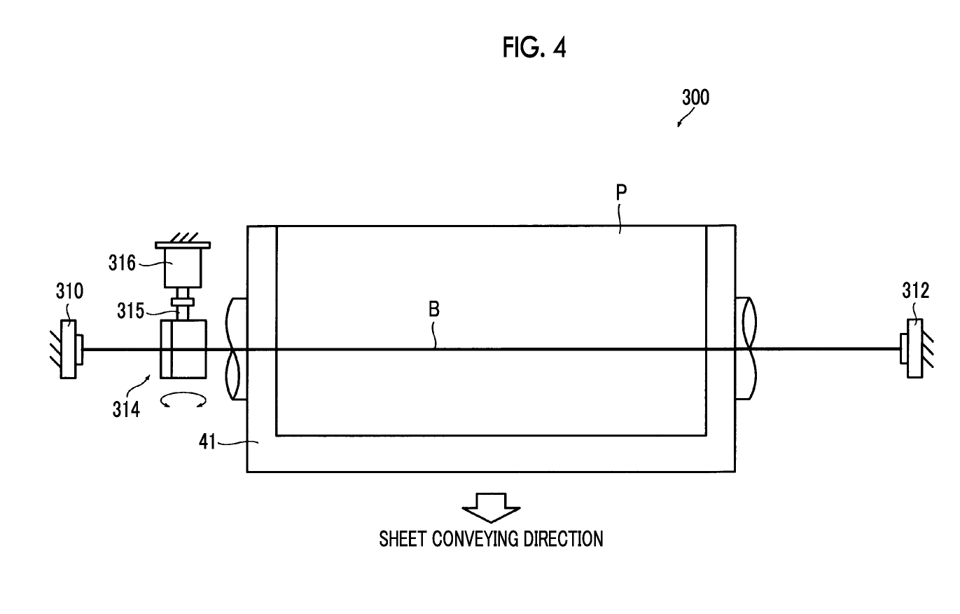

FIGS. 3 and 4 are a front view and a plan view of a first embodiment of the detection device, respectively.

The detection device 300 mainly includes detection means and a variable detection height mechanism. As shown in FIGS. 3 and 4, the detection means includes a light projecting unit (light projecting section) 310 that emits a detection beam (laser beam) B and a light receiving unit (light receiving section) 312 that receives the detection beam B emitted from the light projecting unit 310. Further, the variable detection height mechanism includes a light-projecting glass parallel flat plate 314 that is disposed in front of the light projecting unit 310, a light-projecting motor 316 (light-projecting parallel flat plate rotation-driving means) that rotationally drives the light-projecting glass parallel flat plate 314, and a light-projecting starting point position detecting sensor 318 that detects the starting point position of the light-projecting glass parallel flat plate 314.

The light projecting unit 310 and the light receiving unit 312 form the detection means for detecting the floating of the sheet P and foreign matter. The light projecting unit 310 and the light receiving unit 312 are disposed so as to face each other with the image recording drum 41 interposed therebetween (the light projecting unit 310 and the light receiving unit 312 are disposed so as to face each other with the conveying path of the sheet P interposed therebetween).

The light projecting unit 310 is mounted on a body frame of the inkjet recording apparatus 10 via a bracket (not shown). The light projecting unit 310 includes a light-projecting element, and emits a detection beam B to the light receiving unit 312 from the light-projecting element.

Here, the detection beam B is emitted so as to be parallel to a rotation axis T of the image recording drum 41 (=so as to be orthogonal to a conveying direction of the sheet P). Further, the detection beam B is emitted so as to pass through a position that has a predetermined height H from the outer peripheral surface of the image recording drum 41 (conveying surface). Accordingly, the light projecting unit 310 is installed so as to satisfy this condition.

The system controller 200 controls the emission of the detection beam B by controlling the driving of the light projecting unit 310.

The light receiving unit 312 is mounted on the body frame of the inkjet recording apparatus 10 via a bracket (not shown). The light receiving unit 312 includes a light-receiving element (for example, a transmission type photoelectric element), and receives the detection beam B, which is emitted from the light projecting unit 310, by the light-receiving element. The light-receiving element is provided so as to face the light-projecting element of the light projecting unit 310, and receives the detection beam B that is emitted to the position, which has a predetermined height H from the outer peripheral surface of the image recording drum 41, from the light-projecting element so as to be parallel to the rotation axis T of the image recording drum 41.

Information about the reception of the detection beam B, which is performed by the light receiving unit 312, (the amount of received light) is output to the system controller 200. The system controller 200 determines whether or not the floating of the sheet P and foreign matter are present on the basis of the information about the reception of the detection beam B that is performed by the light receiving unit 312. Specifically, the system controller 200 detects whether or not the detection beam is received by the light receiving unit 312. If the detection beam is not received, the system controller 200 determines that the detection beam B is blocked by the sheet P or foreign matter and determines that the floating of the sheet P occurs or foreign matter are present.

The light-projecting glass parallel flat plate 314 is formed of a rectangular transparent glass plate that includes an incident surface 314a and a light emitting surface 314b parallel to each other. The light-projecting glass parallel flat plate 314 is disposed in front of the light projecting unit 310 (between the light projecting unit 310 and the image recording drum 41), and is provided so as to be rotatable about a rotating shaft 315 that is provided on a downstream side surface thereof in the conveying direction of the sheet P. The light-projecting glass parallel flat plate 314 is disposed so that the rotating shaft 315 is disposed to be parallel to the conveying surface of the sheet P (here, so as to be parallel to a tangential direction of the image recording drum 41 at a position through which the detection beam B passes) and to be orthogonal to the detection beam B emitted from the light projecting unit 310. Further, the light-projecting glass parallel flat plate 314 is disposed so that the detection beam B emitted from the light projecting unit 310 is incident on the substantially middle portion of the incident surface 314a of the light-projecting glass parallel flat plate 314.

The detection beam B emitted from the light projecting unit 310 passes through the light-projecting glass parallel flat plate 314 and is received by the light receiving unit 312.

Here, when the incident surface 314a of the light-projecting glass parallel flat plate 314 is perpendicular to the detection beam B, the detection beam B, which is incident on the light-projecting glass parallel flat plate 314, travels straight just as it is and is emitted from the light emitting surface 314b. Meanwhile, when the incident surface 314a of the light-projecting glass parallel flat plate 314 is inclined with respect to the detection beam B, an optical axis is shifted upward or downward (is shifted upward or downward by a refractive index) due to refraction and is emitted from the light emitting surface 314b.

That is, it is possible to change the height h of the detection beam B, which passes above the image recording drum, by changing the inclination angle of the light-projecting glass parallel flat plate 314. Further, it is possible to change the inclination angle of the light-projecting glass parallel flat plate 314 by rotating the light-projecting glass parallel flat plate 314.

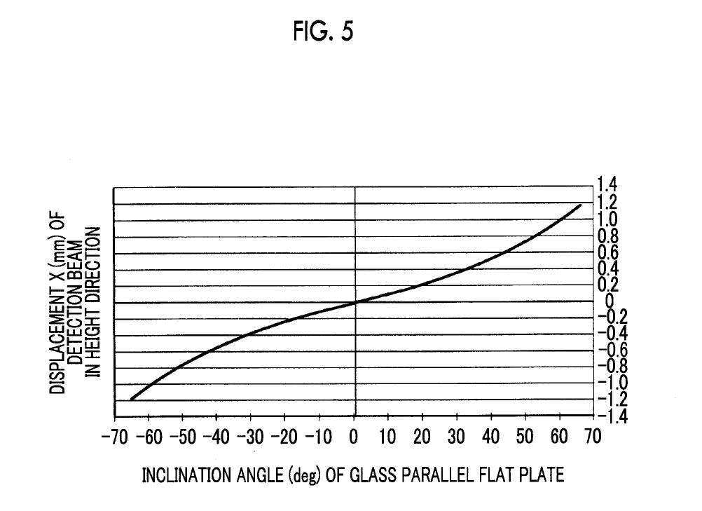

FIG. 5 is a graph showing a relationship between the rotation angle (inclination angle) of the light-projecting glass parallel flat plate 314 and the displacement X of the detection beam in a height direction.

In FIG. 5, the posture of the light-projecting glass parallel flat plate, which is perpendicular to the detection beam B, corresponds to 0°, the rotation angle thereof in a counterclockwise direction corresponds to plus (+), and the rotation angle thereof in a clockwise direction corresponds to minus (−).

As shown in FIG. 5, the detection beam B is displaced upward or downward according to the rotation angle (inclination angle) of the light-projecting glass parallel flat plate 314.

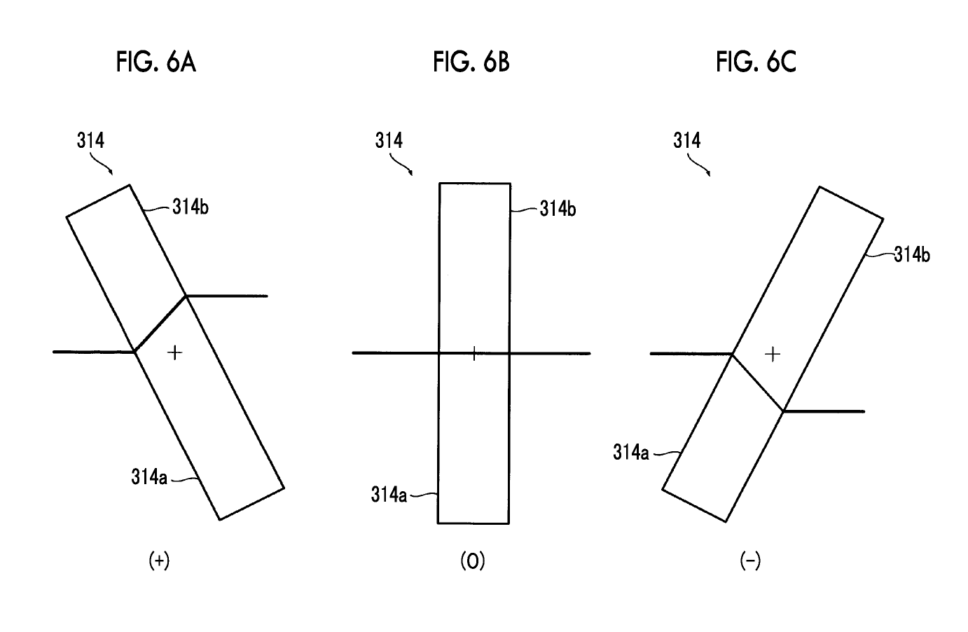

Accordingly, it is possible to adjust the height h of the detection beam B, which passes above the image recording drum 41, (=the position of the detection beam B emitted from the light emitting surface 314b) by adjusting the rotation angle (inclination angle) 0 of the light-projecting glass parallel flat plate 314 as shown in FIGS. 6A to 6C. Further, since the height can be finely adjusted (resolution is high) as shown in FIG. 5, the height of the detection beam can be adjusted with high precision.

The light-projecting motor 316 rotationally drives the light-projecting glass parallel flat plate 314. The light-projecting motor 316 is formed of, for example, a pulse motor that can be driven in a normal direction and a reverse direction, and is mounted on the body frame of the inkjet recording apparatus 10 via a bracket (not shown). The light-projecting glass parallel flat plate 314 is mounted on an output shaft of the light-projecting motor 316, and is disposed at a predetermined position. Accordingly, it is possible to rotate the light-projecting glass parallel flat plate 314 (in a normal direction and a reverse direction) by driving the light-projecting motor 316.

The system controller 200 controls the height h of the detection beam B by controlling the driving of the light-projecting motor 316 to control the rotation angle (inclination angle) of the light-projecting glass parallel flat plate 314.

The light-projecting starting point position detecting sensor 318 detects that the light-projecting glass parallel flat plate 314 is positioned at a starting point position. That is, the light-projecting starting point position detecting sensor 318 detects that the inclination angle of the light-projecting glass parallel flat plate 314 is 0° (the incident surface 314a of the light-projecting glass parallel flat plate 314 is not inclined with respect to the detection beam B emitted from the light projecting unit 310). The light-projecting starting point position detecting sensor 318 is formed of, for example, a proximity sensor (a magnetic sensor or the like), and is installed at a position directly below the light-projecting glass parallel flat plate 314 when the inclination angle is 0°. An element to be detected (not shown) is mounted on the lower surface of the light-projecting glass parallel flat plate 314, and the light-projecting starting point position detecting sensor 318 detects that the inclination angle of the light-projecting glass parallel flat plate 314 is 0° by detecting the element to be detected. The output of the light-projecting starting point position detecting sensor 318 is output to the system controller 200, and the system controller 200 detects that the inclination angle of the light-projecting glass parallel flat plate 314 is 0° on the basis of the output of the light-projecting starting point position detecting sensor 318. That is, the system controller 200 detects that the light-projecting glass parallel flat plate is positioned at the starting point position.

Meanwhile, the configuration of the light-projecting starting point position detecting sensor 318 is not limited thereto, and the light-projecting starting point position detecting sensor 318 can employ other configurations. Further, the element to be detected is detected in a contactless manner by a proximity sensor in the above-mentioned embodiment, but a contact type sensor may be used to detect the element to be detected.

[Action]

Next, the action of the detection device 300 according to this embodiment having the above-mentioned configuration will be described.

The detection of the floating of the sheet P or the detection of foreign matter is performed by projecting the detection beam B to a position having a predetermined height from the conveying surface of the sheet P (=in this embodiment, the outer peripheral surface of the image recording drum 41) and detecting whether or not the detection beam is blocked by the sheet P or foreign matter. Further, whether or not the detection beam is blocked by the sheet P or foreign matter is detected through the detection of whether or not the detection beam B is received by the light receiving unit 312. That is, when the detection beam B is blocked by the sheet P or foreign matter, the detection beam B is not received by the light receiving unit 312. Accordingly, the presence of the floating of the sheet P or the foreign matter is detected on the basis of the fact that the detection beam B is not received by the light receiving unit 312.

Detection is performed by the detection device 300 in a state in which the sheet P is not conveyed (first state) and a state in which the sheet P is conveyed (second state). Meanwhile, the detection of the presence of the floating of the sheet P or foreign matter is performed while the conveying means is driven.

(Detection of Foreign Matter)

A detection height h1 for foreign matter is set. It is preferable that the detection height for foreign matter is 1.0 mm or more from the conveying surface (the surface of an impression cylinder). When the detection height for foreign matter is set to 1.0 mm or more, it is possible to prevent the reflection of a laser on the conveying surface or false detection in a recess in which claws holding a sheet are present. Meanwhile, since foreign matter present on the conveying surface cannot be detected when the detection height for foreign matter from the conveying surface is too great, it is preferable that an upper limit of the detection height for foreign matter from the conveying surface is 2.0 mm or less. The upper limit of the detection height for foreign matter is more preferably 1.5 mm or less and is still more preferably 1.2 mm or less from the conveying surface.

In the detection device 300 of this embodiment, the height of the detection beam B can be changed by the rotation of the light-projecting glass parallel flat plate 314. Accordingly, the height of the detection beam B can be easily changed to the detection height h1 for foreign matter.

It is preferable that the rotational speed of the impression cylinder at the time of detecting foreign matter is slower than the rotational speed of the impression cylinder at the time of printing.

The detection of foreign matter is performed through the detection of whether or not the detection beam B is received by the light receiving unit 312. That is, when foreign matter is present, the detection beam B is blocked by the foreign matter. Accordingly, the detection beam B is not received by the light receiving unit 312 (the amount of received light is equal to or smaller than a threshold). The system controller 200 determines that foreign matter is present on the basis of the fact that the detection beam B is not received by the light receiving unit 312, and performs a predetermined warning operation (the turning-on of the rotary warning light, the generation of a warning sound from the speaker, or the like). At the same time, the system controller 200 stops the conveying means, such as the impression cylinder (control mechanism).

In this embodiment, it is preferable that the detection of foreign matter is performed over the entire conveying path (the detection of foreign matter is continuously performed in the flow direction of a sheet) to make the control mechanism effective.

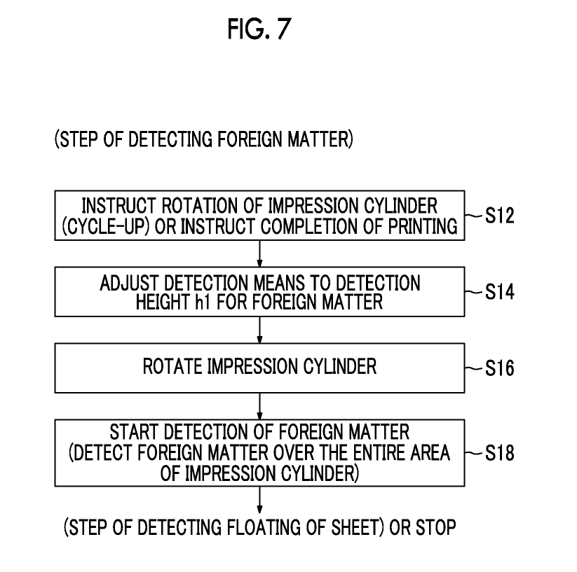

FIG. 7 is a flowchart illustrating a procedure for detecting foreign matter.

First, an instruction of cycle-up or an instruction of the completion of printing is input to the system controller 200 (Step 12). The system controller 200 drives the light-projecting motor 316 to rotate the light-projecting glass parallel flat plate 314 so that the detection means is adjusted to the detection height h1 for foreign matter by the variable detection height mechanism (Step 14). When the detection means is adjusted by the variable detection height mechanism so as to detect foreign matter present at the position of the detection height h1 for foreign matter, the system controller 200 drives the conveying means (the impression cylinder) (Step 16). When the conveying means is driven, the detection of foreign matter is started (Step 18). The detection of foreign matter is continued until an instruction of printing or an instruction for stopping the driving of the conveying means is taken from the system controller 200. Further, when foreign matter is detected by the detection means, the conveying means is immediately stopped by the control mechanism. Accordingly, an operator performs maintenance, cleaning, or the like.

(Detection of Floating of Sheet)

A detection height h2 for the floating of the sheet P is set. The detection height h2 for the floating of the sheet P is adjusted according to the thickness of the sheet P by the variable detection height mechanism. For example, a value (t+α), which is obtained by adding an allowable value α for predetermined floating to the thickness t of the sheet P, is set.

The setting of the detection height h2 for the floating of the sheet P is performed by setting the height of the detection beam B (the detection beam passing above the image recording drum 41), which passes through the light-projecting glass parallel flat plate 314, to a position that has a height h2 (=t+α) from the conveying surface (the outer peripheral surface of the image recording drum 41) by the variable detection height mechanism.

In the detection device 300 of this embodiment, the height of the detection beam B can be changed by the rotation of the light-projecting glass parallel flat plate 314. Accordingly, the height of the detection beam B can be easily changed to the detection height h2 for the floating of the sheet P.

Similar to the detection of foreign matter, the detection of the floating of the sheet P is performed through the detection of whether or not the detection beam B is received by the light receiving unit 312. That is, when floating occurs on the sheet P, the detection beam B is blocked by the floating sheet P. Accordingly, the detection beam B is not received by the light receiving unit 312 (the amount of received light is equal to or smaller than a threshold). The system controller 200 determines that the floating of the sheet P occurs on the basis of the fact that the detection beam B is not received by the light receiving unit 312, and performs a predetermined warning operation (the turning-on of the rotary warning light, the generation of a warning sound from the speaker, or the like). At the same time, the system controller 200 stops the conveying means, such as the impression cylinder (control mechanism).

In this embodiment, it is preferable that the detection of the floating of a sheet is performed only in an area of the conveying surface corresponding to a sheet. When the detection of the floating of a sheet at the time of printing is limited to only the area corresponding to a sheet, claw portions (grippers) and the like are not detected. Accordingly, false detection can be prevented.

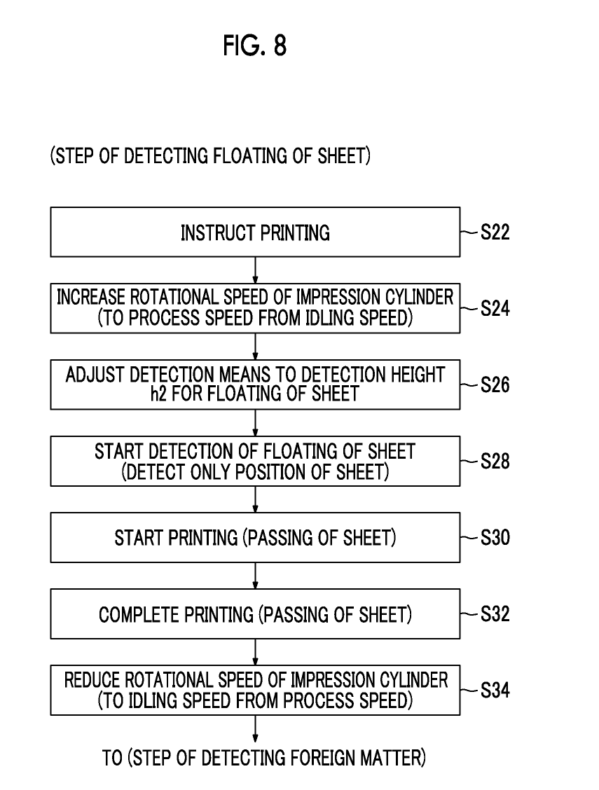

FIG. 8 is a flowchart illustrating a procedure for detecting the floating of a sheet.

First, an instruction of printing is input to the system controller 200 (Step 22). When an instruction of printing is input, the speed of the conveying means such as the impression cylinder is adjusted to a process speed from an idling speed (Step 24). The system controller 200 drives the light-projecting motor 316 to rotate the light-projecting glass parallel flat plate 314 so that the detection means is adjusted to the detection height h2 for the floating of the sheet P by the variable detection height mechanism (Step 26). In this case, if the inkjet heads 44C, 44M, 44Y, and 44K are positioned at the maintenance unit (retreat position), the inkjet heads 44C, 44M, 44Y, and 44K are made to move to a printing position (drawing position). When the detection means is adjusted by the variable detection height mechanism so as to detect the floating of the sheet occurring at the position of the detection height h2 for the floating of the sheet, the detection of the floating of the sheet P is started (Step 28). Printing on the sheet is started (Step 30), and the printing is then completed (Step 32). When the floating of the sheet is detected by the detection means during the printing, the conveying means is immediately stopped by the control mechanism. When the floating of the sheet is not detected and the printing is completed without problem, the speed of the conveying means such as the impression cylinder is adjusted to an idling speed from a process speed (Step 34). In this case, the inkjet heads 44C, 44M, 44Y, and 44K are made to move to the maintenance unit (retreat position) from the printing position. When the speed of the conveying means, such as the impression cylinder, is adjusted to the idling speed, the procedure proceeds to a flowchart of FIG. 7 that illustrates the procedure for detecting foreign matter. That is, when a step of detecting the floating of a sheet ends, the procedure proceeds to the step of detecting foreign matter.

As described above, in the detection device 300 according to this embodiment, the height of the detection beam B of the detection means can be changed by the rotation of the light-projecting glass parallel flat plate 314 of the variable detection height mechanism. Accordingly, the height of the detection beam B can be easily changed to the detection height h2 for the floating of the sheet P and the detection height h1 for foreign matter.

Further, since the detection device 300 according to this embodiment is adapted to displace an optical axis by a refractive index through the rotation of the light-projecting glass parallel flat plate 314, the height of the detection beam can be adjusted with high resolution. Accordingly, the height of the detection beam is set with high precision. Furthermore, when the detection height is set, the conveying surface can be detected and the height can be adjusted. Accordingly, the detection height can be set with high precision. Further, it is possible to perform detection that is resistant to a change with time and is stable.

### Second Embodiment

### Configuration

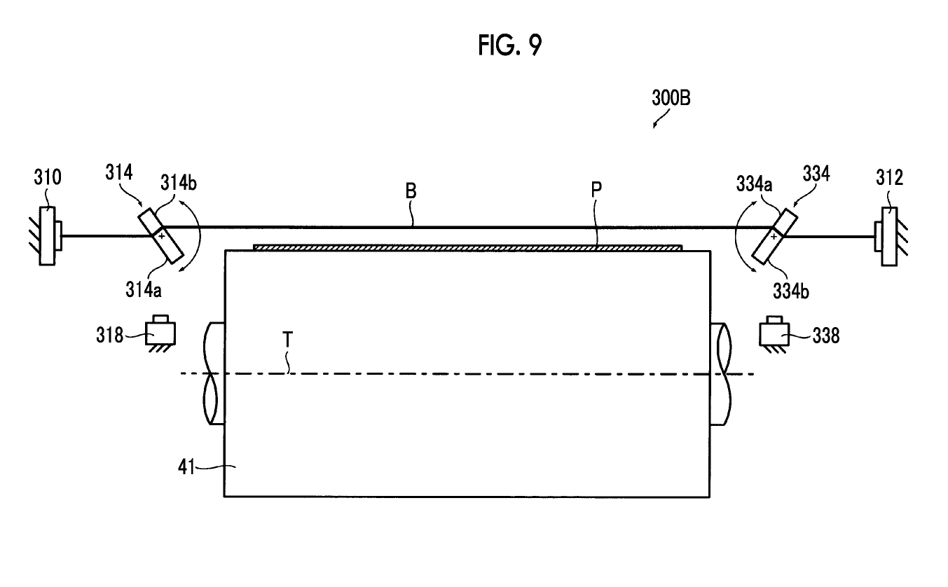

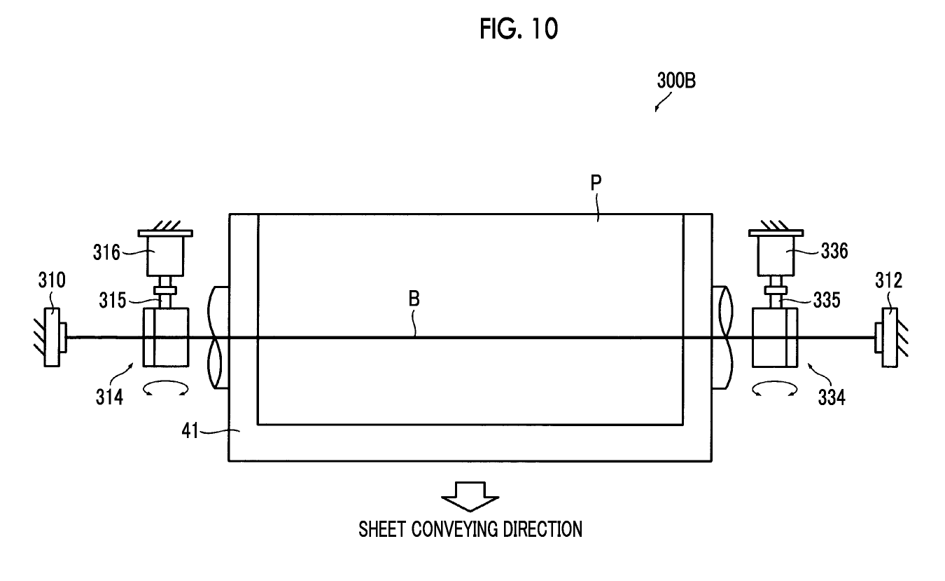

FIGS. 9 and 10 are a front view and a plan view of a second embodiment of a sheet floating detection device, respectively.

As shown in FIGS. 9 and 10, a detection device 300B of this embodiment also includes a glass parallel flat plate provided on a light-receiving side. Accordingly, the position of an optical axis of a detection beam B can also be adjusted on the light-receiving side.

Meanwhile, since the configuration on a light-projecting side is the same as that of the first embodiment, only the configuration on the light-receiving side will be described here.

As shown in FIGS. 9 and 10, a light-receiving glass parallel flat plate 334, a light-receiving motor 336 (light-receiving parallel flat plate rotation-driving means) that rotationally drives the light-receiving glass parallel flat plate 334, and a light-receiving starting point position detecting sensor 338 that detects the starting point position of the light-receiving glass parallel flat plate 334 are provided in front of the light receiving unit 312 (between the light receiving unit 312 and the image recording drum 41).

Similar to the light-projecting glass parallel flat plate 314, the light-receiving glass parallel flat plate 334 is formed of a rectangular transparent glass plate that includes an incident surface 334a and a light emitting surface 334b parallel to each other. The light-receiving glass parallel flat plate 334 is disposed in front of the light receiving unit 312 (between the light receiving unit 312 and the image recording drum 41), and is provided so as to be rotatable about a rotating shaft 335 that is provided on a downstream side surface thereof in the conveying direction of the sheet P. The light-receiving glass parallel flat plate 334 is disposed so that the rotating shaft 335 is disposed to be parallel to the conveying surface of the sheet P (here, so as to be parallel to a tangential direction of the image recording drum 41 at a position through which the detection beam B passes) and to be orthogonal to the detection beam B emitted from the light projecting unit 310. Further, the light-receiving glass parallel flat plate 334 is disposed so that the center of the light emitting surface 334b substantially corresponds to the center of the light-receiving surface of the light receiving unit 312.

The detection beam B, which has passed through the light-projecting glass parallel flat plate 314, passes through the light-receiving glass parallel flat plate 334 and is received by the light receiving unit 312.

Here, when the incident surface 334a of the light-receiving glass parallel flat plate 334 is perpendicular to the detection beam B, the detection beam B, which is incident on the light-receiving glass parallel flat plate 334, travels straight just as it is and is emitted from the light emitting surface 334b. Meanwhile, when the incident surface 334a of the light-receiving glass parallel flat plate 334 is inclined with respect to the detection beam B, an optical axis is shifted upward or downward (is shifted upward or downward by a refractive index) due to refraction and is emitted from the light emitting surface 334b.

That is, it is possible to change the height position of the detection beam B, which is received by the light receiving unit 312, by changing the inclination angle of the light-receiving glass parallel flat plate 334. Further, it is possible to change the inclination angle of the light-receiving glass parallel flat plate 334 by rotating the light-receiving glass parallel flat plate 334.

The light-receiving motor 336 rotationally drives the light-receiving glass parallel flat plate 334. The light-receiving motor 336 is formed of, for example, a pulse motor that can be driven in a normal direction and a reverse direction, and is mounted on the body frame of the inkjet recording apparatus 10 via a bracket (not shown). The light-receiving glass parallel flat plate 334 is mounted on an output shaft of the light-receiving motor 336, and is disposed at a predetermined position. Accordingly, it is possible to rotate the light-receiving glass parallel flat plate 334 (in a normal direction and a reverse direction) by driving the light-receiving motor 336.

The system controller 200 controls the height position of the detection beam B, which is incident on the light receiving unit 312, by controlling the driving of the light-receiving motor 336 to control the rotation angle (inclination angle) of the light-receiving glass parallel flat plate 334.

The light-receiving starting point position detecting sensor 338 detects that the light-receiving glass parallel flat plate 334 is positioned at a starting point position. That is, the light-receiving starting point position detecting sensor 338 detects that the inclination angle of the light-receiving glass parallel flat plate 334 is 0° (the incident surface 334a of the light-receiving glass parallel flat plate 334 is not inclined with respect to the detection beam B). The light-receiving starting point position detecting sensor 338 is formed of, for example, a proximity sensor (a magnetic sensor or the like), and is installed at a position directly below the light-receiving glass parallel flat plate 334 when the inclination angle is 0°. An element to be detected (not shown) is mounted on the lower surface of the light-receiving glass parallel flat plate 334, and the light-receiving starting point position detecting sensor 338 detects that the inclination angle of the light-receiving glass parallel flat plate 334 is 0° by detecting the element to be detected. The output of the light-receiving starting point position detecting sensor 338 is output to the system controller 200, and the system controller 200 detects that the inclination angle of the light-receiving glass parallel flat plate 334 is 0° on the basis of the output of the light-receiving starting point position detecting sensor 338. That is, the system controller 200 detects that the light-receiving glass parallel flat plate is positioned at the starting point position.

Meanwhile, the configuration of the light-receiving starting point position detecting sensor 338 is not limited thereto, and the light-receiving starting point position detecting sensor 338 can employ other configurations. Further, the element to be detected is detected in a contactless manner by a proximity sensor in the above-mentioned embodiment, but a contact type sensor may be used to detect the element to be detected.

[Action]

The action and detection method of the detection device 300B of this embodiment having the above-mentioned configuration are the same as those of the detection device 300 of the first embodiment (the detection device 300B detects whether or not the detection beam B is blocked).

### OTHER EMBODIMENTS

A case in which the floating of the sheet conveyed by the conveying drum (impression cylinder) is detected has been described by way of example in a series of the above-mentioned embodiments, but the application of the invention is not limited thereto. The invention can also be applied to a case in which a sheet is conveyed by other conveying means. Similarly, the invention can also be likewise applied to a case in which the floating of a sheet conveyed by, for example, a conveyor belt is detected. Further, the invention can also be applied to a case in which a sheet is conveyed so as to slide on a predetermined conveying surface without being limited to a case in which a sheet is conveyed while being held by suction or the like. For example, the invention can also be applied to a case in which the floating of a sheet conveyed on a platen is detected.

Further, plates made of glass have been used as the light-projecting parallel flat plate and the light-receiving parallel flat plate in the embodiments, but materials of the parallel flat plats are not limited thereto. Parallel flat plats made of other materials may be used.

According to this embodiment, since the detection device for detecting the floating of a sheet detects foreign matter during the driving of the conveying mechanism except during printing as described above, the detection device can detect foreign matter (also including paper and the like remaining in the apparatus) present on the conveying surface. Accordingly, it is possible to prevent a sheet or foreign matter from coming into contact with the inkjet head.

### EXPLANATION OF REFERENCES

10: inkjet recording apparatus
20: sheet feed section
21: sheet feed device
22: sheet feed tray
23: transfer cylinder
30: treatment liquid applying section
31: conveying drum (treatment liquid applying drum)
32: treatment liquid applying device
40: image recording section
41: conveying drum (image recording drum)
42: sheet pressing roller
44C, 44M, 44Y, 44K: inkjet head
50: ink drying section
51: conveying drum (ink drying drum)
52: ink drying device
60: fixing section
61: conveying drum (fixing drum)
62, 63: heating roller
64: in-line sensor
70: recovery section
71: stacker
72: sheet discharge conveyor
80: transfer cylinder
81: transfer cylinder body
83: guide plate
84: dryer
90: transfer cylinder
91: transfer cylinder body
93: guide plate
94: dryer
100: transfer cylinder
101: transfer cylinder body
103: guide plate
104: dryer
200: system controller
201: communication section
202: image memory
203: conveyance control section
204: sheet feed control section
205: treatment liquid application control section
206: image recording control section
207: ink drying control section
208: fixing control section
209: recovery control section
210: operation section
211: display section
212: warning section
300, 300B: detection device
310: light projecting unit
312: light receiving unit
314: light-projecting glass parallel flat plate
314a: incident surface
314b: light emitting surface
315: rotating shaft
316: light-projecting motor
318: light-projecting starting point position detecting sensor
334: light-receiving glass parallel flat plate
334a: incident surface
334b: light emitting surface
335: rotating shaft
336: light-receiving motor
338: light-receiving starting point position detecting sensor
P: sheet (recording medium)
B: detection beam
G: gripper

What is claimed is:

1. An inkjet recording apparatus comprising:
conveying means for conveying a recording medium along a conveying path;
an inkjet head that draws an image by dropping ink on a recording surface of the recording medium conveyed by the conveying means;
detection means that includes a light projecting section for emitting a detection beam parallel to a conveying surface and a light receiving section on which the detection beam is incident; and
a variable detection height mechanism that changes a height of the detection beam from the conveying surface in a first state in which the conveying means is driven and does not convey the recording medium and a second state in which the conveying means is driven and conveys the recording medium,
wherein the detection means detects foreign matter in the first state, and detects the floating of the recording medium in the second state.

2. The inkjet recording apparatus according to claim 1, further comprising:
a control mechanism that detects whether or not the detection beam is received by the light receiving section and stops the conveying means when the detection beam is not received.

3. The inkjet recording apparatus according to claim 2,
wherein a control, which maintains a first detection height from the conveying surface and makes the control mechanism effective over the entire conveying path, is performed in the first state, and
a control, which maintains a second detection height from the conveying surface and makes the control mechanism effective only in an area in which the recording medium is present in the conveying path, is performed in the second state.

4. The inkjet recording apparatus according to claim 1,
wherein the detection height of the first state is 1.0 mm or more from the conveying surface.

5. The inkjet recording apparatus according to claim 1,
wherein the detection height of the second state is adjusted according to the thickness of the recording medium by the variable detection height mechanism.

6. The inkjet recording apparatus according to claim 1,
wherein the inkjet head is movable between a drawing position where the inkjet head draws an image by dropping ink on a recording surface of the recording medium conveyed by the conveying means and a retreat position where the inkjet head is retreated from the conveying means, and is moved to the retreat position in the first state and moved to the drawing position in the second state.

7. The inkjet recording apparatus according to claim 1,
wherein a speed of the conveying means in the first state is lower than that in the second state.

8. The inkjet recording apparatus according to claim 1,
wherein the conveying means is a conveying drum that holds the recording medium on an outer peripheral surface thereof by suction and conveys the recording medium by being rotated.

9. The inkjet recording apparatus according to claim 1,
wherein the variable detection height mechanism includes
a light-projecting parallel flat plate that is disposed in front of the light projecting section so as to allow the detection beam emitted from the light projecting section to pass through the light-projecting parallel flat plate, is provided so as to be rotatable about an axis parallel to the conveying surface and orthogonal to the detection beam, and changes a height of the detection beam, which passes through the light-projecting parallel flat plate and is emitted from the light-projecting parallel flat plate, by being rotated, and
light-projecting parallel flat plate rotation-driving means for rotationally driving the light-projecting parallel flat plate.

10. The inkjet recording apparatus according to claim 9,
wherein the variable detection height mechanism includes
a light-receiving parallel flat plate that is disposed in front of the light receiving section so as to allow the detection beam having passed through the light-projecting parallel flat plate to pass through the light-receiving parallel flat plate, is provided so as to be rotatable about an axis parallel to the conveying surface and orthogonal to the detection beam, and changes a height of the detection beam, which passes through the light-receiving parallel flat plate and is emitted from the tight-receiving parallel flat plate, by being rotated, and
light-receiving parallel flat plate rotation-driving means for rotationally driving the light-receiving parallel flat plate.
